(19) United States
(12) Patent Application Publication
(10) Pub. No.: US 2003/0189094 A1
(43) Pub. Date: Oct. 9, 2003

(54) Baggage tracking system

(76) Inventor: Eugene L. Trabitz, San Mateo, CA (US)

Correspondence Address: BURNS DOANE SWECKER & MATHIS L L P, POST OFFICE BOX 1404, ALEXANDRIA, VA, 22313-1404, US

(21) Appl. No.: 10/119,802

(22) Filed: Apr. 9, 2002

(51) Int. Cl. G06F 17/60

(52) U.S. Cl. 235/385

(57) ABSTRACT

A passenger and baggage reconciliation system is described that employs non-programmable, passive transponder, radio frequency identification (RFID) tags attached to checked baggage, which enables continuity of reconciliation through any number of intra-air transfer points until the destination of the air travel is reached. If separation of the passenger and baggage occurs prior to the planned air travel destination, the system furnishes prompt notification to the airline. While enrollment of the passenger occurs upon payment for travel, checked baggage enrollment can occur variously outside the airport building (curbside), at the ticket counter, at the departure gate, on board the airplane, or along side the airplane prior to mounting the stairway or on the jet bridge. The interface to the airline carrier's computer reservation system (CRS) to obtain passenger and schedule data permits continuous tracking of passengers and baggage for the reconciliation process. The CRS creates a passenger name record (PNR) for each traveler, which contains fields for entering identification codes for checked baggage. Separate PNR fields and codes are used for each item of baggage that is checked. The PNR entry is obtained from reading the embedded identification number on the attached RFID tag when the baggage is checked in.

### BACKGROUND OF THE INVENTION

The present invention relates baggage handling systems, especially to baggage handling systems that can ensure the reconciliation of a passenger and their baggage on a plane.

One known airplane security issue concerns passenger and baggage reconciliation. A terrorist may be able to place a bomb in a piece of checked baggage and then not get onto the flight. If the baggage containing the bomb is not removed, the bomb can destroy the airplane without harm to the terrorist. For this reason, on many flights, it is required that when a checked-in passenger does not take a flight, the passenger's baggage is removed from the airplane. Using current baggage handling systems, finding and removing such baggage can be quite difficult.

In the current baggage handling system, each piece of checked-in baggage has a printed tag listing the final destination airport and indicating the flights for the trip. Typically, a bar code is also provided on the printed label. Under the current baggage handling systems, whenever baggage must be removed from the plane, the airplane cargo bays need to be searched visually to isolatethe passenger's baggage. Normally this search requires removal of much baggage from the cargo bays to identify the correct bag(s), and it can take a considerable amount of time.

Itineraries with multiple connecting flights pose special problems. With connecting flights, baggage is moved from the originating plane to the connecting plane. Frequently, the second leg of the trip changes after check-in. Since the printed label on the bag contains only the original flight information, it is quite difficult to redirect the baggage so that it is transferred to the connecting plane for the second leg of the itinerary.

It is desired to have a system and method that makes it easier to ensure that both the passenger and the baggage are on the same flight for security reasons and for avoiding cost to the airline from having to locate and retrieve baggage that is separated from the passenger.

### SUMMARY OF THE INVENTION

One embodiment of the present invention includes a system in which a Radio Frequency Identification (RFID) tag gets attached to a piece of baggage. At check-in, the RFID tag information is associated with information from an airline reservation system for a passenger's trip. In one embodiment, the serial number from the RFID tag is put into a database field associated with the trip information. The baggage is preferably tracked using the RFID tag. At different locations, RFID readers read the RFID tag as the baggage moves through the system. If the baggage is improperly loaded into any location, an alarm or other display is preferably produced indicating that baggage is being sent to the wrong location. This alarm requires the handler to treat the bag in a special manner. As long as the baggage is within a certain distance from the RFID reader, the serial number from the RFID tag is automatically obtained. Since the RFID tag information is associated with information from the airline reservation system, a processor at the RFID reader automatically determines whether the baggage is put in the right location. In one embodiment, a stored indication is created when the baggage is loaded onto the airplane. When the passenger gets on the same airplane, a second indication is stored. Thus, the system checks to determine whether the baggage is loaded onto a plane and the passenger is not on the plane.

Since the RFID tag system is associated with information from the airline reservation system, for multi-flight trips, a passenger can change flights for the second hop and then, automatically, the system will indicate to the baggage handlers, as they are handling the bags, where to correctly send the baggage. This makes it much easier for the airline to both switch passenger flights, and ensure that for the second leg of the trip, both the passenger and the baggage are on the same plane.

### BRIEF DESCRIPTION OF THE DRAWING FIGURES

FIG. 1 is a diagram of a method of one embodiment of the system of the present invention.

FIG. 2 is a diagram illustrating a system used in one embodiment of the system of the present invention.

FIG. 3 is a diagram that illustrates the operation of the RFID readers in one embodiment of the present invention.

FIG. 4 is a diagram illustrating one embodiment of the present invention.

FIG. 5 is a timeline illustrating one embodiment of the present invention.

### DETAILED DESCRIPTION OF THE PREFERRED EMBODIMENT

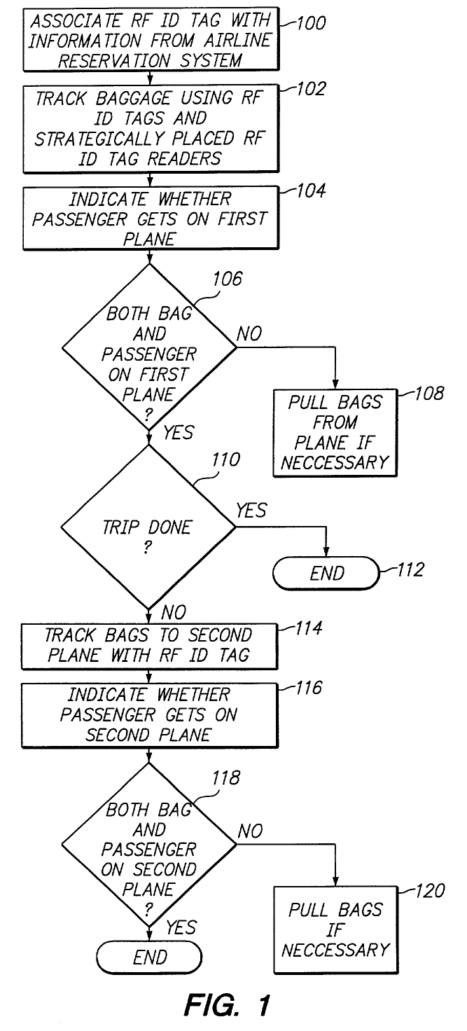

FIG. 1 illustrates one example of an embodiment of the system of the present invention. In step 100, an RFID tag is associated with information from an airline reservation system. In a preferred embodiment, at check-in, the RFID tag is read to obtain the RFID tag ID information serial number. This ID information is associated with information from the airline reservation system. In a preferred embodiment, the information from the airline reservation system includes the user's name, the flight information, including the flight or flights in the itinerary, as well as the destination airport.

In step 102, the baggage is tracked using the RFID tag. In a preferred embodiment, the RFID tag is attached to the baggage, and needs to be positioned within a certain distance from the RFID reader. In a preferred embodiment, the RFID reader interrogates the RFID tag, which responds with the RFID information. In one embodiment, this ID information is used to check for the stored flight information. Since the stored flight information is electronically available, in one embodiment, displays or alarms are produced to ensure that the baggage is in the correct location for the different portions of the baggage tracking. In particular, in a preferred embodiment, it is determined whether the baggage is loaded onto the correct plane.

In step 104, an indication is produced whether the passenger gets on the originating plane. In one embodiment, this indication is produced by reading the ticket as the user enters the plane.

In step 106, it is checked to see whether both the bag and passenger are on the originating plane. If the baggage is on the plane, and the passenger doesn't board the plane, in step 108 the baggage is pulled from the plane. If the trip has a connecting flight, in step 114, the bags are tracked to the connecting plane using the RFID tag. Note that since the RFID tag is associated with the most updated version of the itinerary, the passenger can modify the itinerary and still, as the bags move through the system, the baggage handlers will be given an indication of the correct location to which the bags should be routed. This indication can be different from the information printed on the baggage label.

In step 116, an indication is produced whether the passenger gets on the connecting flight. In step 118, it is checked to see whether or not both the baggage and the passenger are on the same connecting flight. If not, in step 120, the baggage is pulled, if necessary. The system continues to track the passenger and the bagage through as many flights as necessary for the trip.

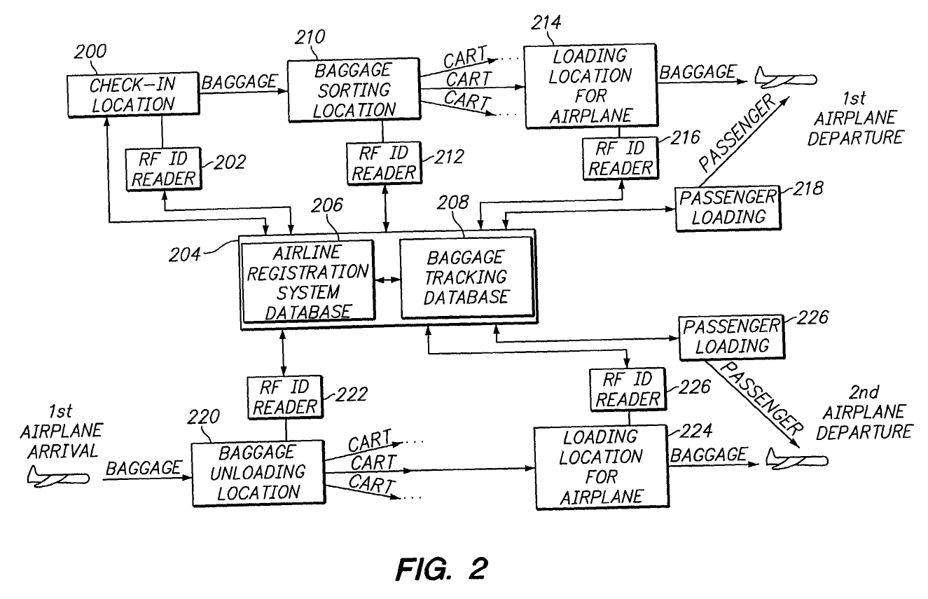

FIG. 2 illustrates another example of a system that operates with the present invention. At the ticket location 200, an RFID reader 202 interrogates an RFID tag attached to the baggage; a new RFID tag can be provided by the airline, or a previously used RFID tag can be retained and reused.

The RFID information is sent to a storage location unit 204, which associates information from the airline reservation system database 206 with the ID information from the baggage. A baggage-tracking database 208 in one embodiment is distinct from the airline reservation system database 206. In another embodiment, the baggage-tracking information is stored in the airline reservation system database 208.

The baggage with the RFID tag is sent to a luggage sorting location 210. At the luggage sorting location 210, the baggage is loaded onto different carts. The RFID reader 212 ensures that the piece of baggage is placed upon the correct cart, headed for the correct airplane. In one embodiment, an RFID reader is mounted on each cart. The airplane loading location 214 also includes an RFID reader 216, which ensures that the piece of baggage, as it is loaded into the airplane, is placed in the correct airplane. In one embodiment, the luggage is put into a storage container that is loaded onto the plane. The storage container preferably includes an RFID reader which reads the RFID information from the RFID tags on baggage loaded onto the storage container and stores the RFID information on a chip. Information on this chip is read out to locate the correct storage container within the airplane for finding the baggage. In one embodiment, RFID readers 202, 212, 216 interact with the computer storage information unit 204. The location of the piece of baggage is tracked as it moves through the airport. Once the piece of baggage is loaded into the airplane, an indication of this information is stored in the unit 204. The ticket-reading unit 218 indicates when a passenger boards the airplane. In one embodiment, the ticket is read by a unit at the gate, which will produce an indication that the passenger has entered the airplane. When baggage is loaded onto the airplane, but the passenger is not on the airplane, an indication is produced which allows the baggage handlers to remove the baggage from the airplane before it is permitted to depart. The use of the RFID tag makes finding the baggage much easier. A portable RFID reader can be used to locate the orphaned baggage for removal. Similarly, when the originating airplane arrives, the baggage is unloaded from the baggage unloading location 220, and an RFID tag reader 222 reads the RFID tag. The cart with the baggage is sent to the location for loading onto the airplane 224. The RFID reader 226 then ensures that the baggage is correctly loaded into the connecting airplane. Additionally, the passenger loading location 226 produces an indication of when the passenger enters the connecting airplane. The indications can be checked to ensure that both the baggage and the passenger are on the connecting airplane.

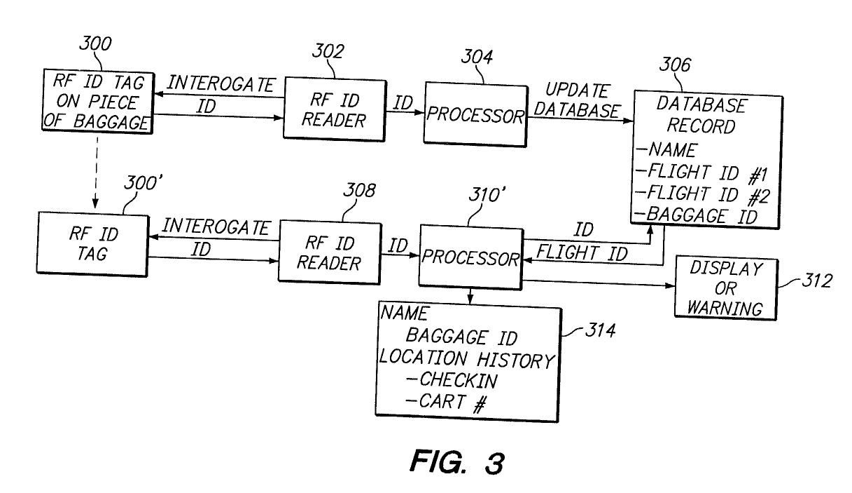

FIG. 3 illustrates an exemplary embodiment of an interrogation system of the present invention. An RFID tag 300 on a baggage is interrogated by an RFID reader 302. This energy interrogation is transmitted to the RFID tag, which responds with the reflected ID. Typically, the RFID tag is a passive device that does not require energy, but uses the interrogation energy from the RFID reader to provide the response of the ID information. In one embodiment, this ID information is sent to a processor 304 which provides the ID to be associated with additional information from an airline reservation system. As the RFID tag 300 moves through the system, the RFID reader 308 interrogates and obtains the ID information from the RFID tag. This ID is sent to a processor 310, which uses the ID to check the database record 306. In response to this interrogation, a flight ID is provided to the processor 310, which can then produce a display or a warning 312 concerning the baggage. For example, in one embodiment, a display is produced of the location of the correct flight information for the baggage as it is being routed. Alternately, a warning such as a tone or flashing lights is produced if the baggage is sent to the wrong cart or placed on the wrong airplane. In one embodiment, another database record 314 is produced which includes the latest location of the baggage as it moves through the system.

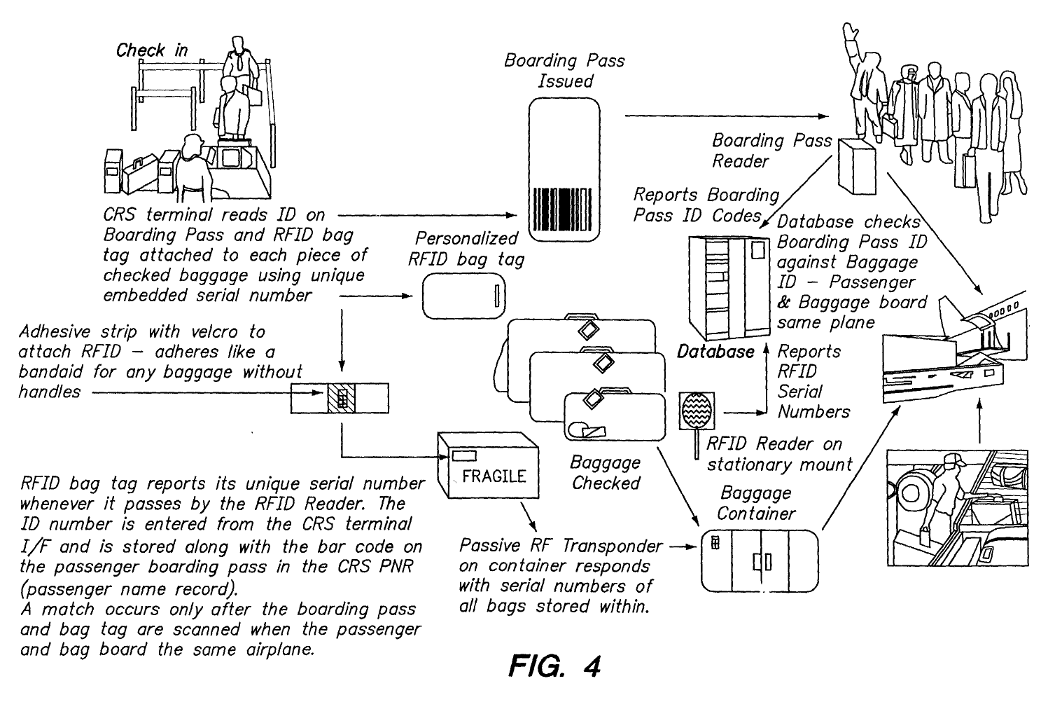

FIG. 4 illustrates one example of the method of one embodiment of the present invention. Note that the RFID tag allows for personalized information such as name, address, etc., to be added to the RFID tag. If the baggage does not include a handle, an adhesive strip, with Velcro or an equivalent, can attach or bond the RFID tag temporarily to the baggage. Alternately, some other attachment method can be used. In a preferred embodiment, the RFID serial number is unique to each RFID tag. The RFID serial number would not need to be permanently associated with the passenger, but can be temporarily associated for a single trip at the time of check-in. FIG. 4 also illustrates a Passive RF Transponder on a container that responds, when interrogated, with the serial numbers of all the baggage stored within. Alternately, some other means of reading out the serial numbers can be used. FIG. 4 also illustrates a boarding pass which uses a magnetic strip or other element so that passenger information is entered into the system when the passenger boards.

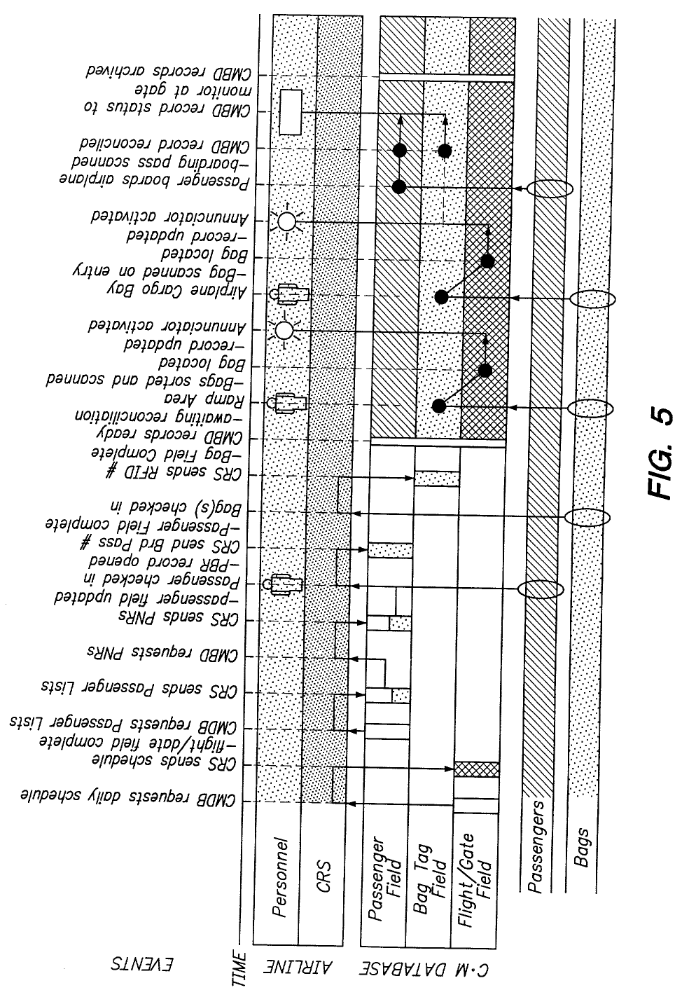

FIG. 5 illustrates an exemplary timeline for one embodiment of the system of the present invention. In this embodiment, the baggage tracking database (CMDB), is handled separately from the airline's computer reservation system. The baggage tracking database requests daily schedules of flights. The computer reservation system sends the schedule for the flights to the baggage tracking database. The baggage tracking database requests the passenger lists. The computer reservation system sends the passenger list. The baggage tracking database requests the passenger name records for all passengers listed for each flight, and the computer reservation system sends the passenger name records, with the baggage field updated. When the passenger checks in, a personal name record is updated to include ID numbers for all checked baggage. The computer reservation system sends a boarding pass number, and the passenger field becomes complete. Next, the bags are checked in. The computer reservation system sends an RFID number, which is stored in the baggage field of the computer reservation system. For all passengers with checked baggage, the baggage-tracking database creates a passenger baggage reconciliation record (PBRR). The PBRR is then ready and waiting to complete the reconciliation of the passenger and the baggage. In the ramp area, the bags are sorted and scanned. When the RFID reader reads the baggage tags, the PBRR in the baggage-tracking database is updated, and the annunciator is activated. At the airplane cargo bay, the baggage tags are again scanned upon entry. This causes the PBRR in the baggage-tracking database to be updated, and activates the annunciator. When the passenger boards the airplane, the boarding pass is scanned and the information is transferred from the computer reservation system to the baggage-tracking system and the PBRR is reconciled. If the PBRR does not reconcile, then an indication will be produced to cause the baggage handler to remove the baggage. The status of all PBRRs will be reported by the baggage-tracking database to a monitor at the gate to help the airline employees determine whether or not the passengers and baggage are reconciled. Finally, the baggage-tracking database records can be archived.

Appendix A illustrates one exemplary embodiment.

It will be appreciated by those of ordinary skill in the art that the invention can be implemented in other specific forms without departing from the spirit or character thereof. The presently disclosed embodiments are therefore considered in all respects to be illustrative and not restrictive. The scope of the invention is illustrated by the appended claims rather than the foregoing description, and all changes that come within the meaning and range of equivalents thereof are intended to be embraced herein.

What is claimed is:

1. A method comprising:
associating an RFID tag attached to a baggage with information obtained from an airline reservation system for a passenger's trip;
tracking the baggage using the RFID tag, the association indicating an airplane to load the baggage, the tracking being such that if the baggage is loaded on the airplane, the RFID tag is read and a first indication is stored;
if the passenger gets on the airplane, storing a second indication; and
using stored indications to determine whether both the passenger and the baggage are on the airplane.

2. The method of claim 1 wherein the first and second indications are stored in a database.

3. The system of claim 2 wherein the database is a baggage tracking database.

4. The system of claim 2 wherein the database is an airline reservations database.

5. The system of claim 1, wherein the RFID tag is checked by an RFID reader at the airplane.

6. The system of claim 1, wherein the RFID readers, at the airport, keep track of the location of the baggage.

7. The system of claim 1 wherein an RFID reader is used to obtain RF information from the RFID tags.

8. The system of claim 1 wherein the system produces an indication that the baggage needs to be removed if the passenger is not on the plane but the baggage is on the plane.

9. The method of claim 1 wherein an indication of a change in flight plans by the passenger is sent to computers associated with RFID readers which ensures that the baggage is sent to the correct plane.

10. The method of claim 1 wherein the baggage is tracked over multiple flights of an itinerary using the RFID tags.

11. The method of claim 1 wherein the RFID tags are reusable.

12. A method comprising:
associating an RFID tag attached to a baggage with information obtained from an airline reservation system for a passenger's trip;
tracking the baggage using the RFID tag, the association indicating an originating airplane to load the baggage, the tracking being such that if the baggage is loaded on the originating airplane, the RFID tag is read and a first indication is stored;
if the passenger boards the originating airplane, storing a second indication; and
using stored indications to determine whether both the passenger and the baggage are on the originating airplane;
after the baggage is removed from the originating airplane, tracking the baggage using the RFID tag, the association indicating a connecting airplane to load the baggage, the tracking being such that if the baggage is loaded on the connecting airplane, the RFID tag is read and a third indication is stored; and
if the passenger gets on the connecting airplane, storing a fourth indication; and
using stored indications to determine whether both the passenger and the baggage are on the connecting airplane.

13. The method of claim 1 wherein the indications are stored in a database.

14. The method of claim 13 wherein the database is a baggage tracking database.

15. The method of claim 13, wherein the database is an airline reservation database.

16. The method of claim 1 wherein an RFID reader reads an RFID tag attached to the baggage as it is being loaded onto the originating and connecting flights.

17. The method of claim 12 wherein storage containers are used to store the baggage on the plane, the storage container including an RFID reader.

18. The system of claim 12 wherein after each of the using steps, if baggage is on the plane and the passenger is not, the baggage is removed from the plane.

19. The method of claim 12 wherein a change in itinerary by a passenger changes data sent to baggage handlers.
